(19) United States
(12) Patent Application Publication
(10) Pub. No.: US 2013/0186836 A1
(43) Pub. Date: Jul. 25, 2013

(54) Method For Removing Arsenic From Water Using Polymer Based Matrices With Chelating Groups Comprising Metal Ions

(71) Applicants: Jan Berglöf, Uppsala (SE); Göran Lindgren, Almunge (SE)

(72) Inventors: Jan Berglöf, Uppsala (SE); Göran Lindgren, Almunge (SE)

(73) Assignee: BIO-WORKS COMPANY LIMITED, Wangchai, Hong Kong (CN)

(21) Appl. No.: 13/877,550

(22) PCT Filed: Oct. 3, 2011
(86) PCT No.: PCT/SE11/00170

§ 371 Date: Apr. 3, 2013

(30) Foreign Application Priority Data
Oct. 5, 2010 (SE) 1000982-7

(51) Int. Cl. C02F 1/62

(52) U.S. Cl. CPC C02F 1/62
USPC 210/668

(57) ABSTRACT

A method for the removal of arsenic in a positive oxidation stage from an aqueous liquid comprising the steps of: i) providing a porous adsorbent which comprises a solid phase carrying a metal ion in a form (I) which is capable of binding the arsenic to give a metal ion form (II) comprising the metal ion and the arsenic; ii) contacting the aqueous liquid with the adsorbent for formation of form (II), iii) separating the aqueous liquid from the adsorbent, iv) optionally regenerating the adsorbent, and reusing it in cycles comprising steps (i)-(iv), The characterizing feature is that A) form (I) is a metal chelate (I), which •comprises a metal ion and a multidentate chelating group, •comprises three or more amino nitrogens which are directly attached to sp³ carbon and in an at least triplet wise manner can coordinate a metal ion, and, •can be transformed to form (II), and/or B) step (ii) prior to the formation of form (II) comprises the substeps of: •oxidising As (+III) to As(+V), and •securing zero amounts of oxidation agent in the aqueous liquid.

### TECHNICAL FIELD

The present invention relates to adsorbent methods and arrangements for the reduction of levels of arsenic which is in a positive oxidation stage in an aqueous liquid. The adsorbents exhibit functional groups as discussed herein causing selective removal of arsenic in a positive oxidation stage. Typical aqueous liquids to be treated comprise community water including drinking water, water from water wells, ground water, water from oil wells and mines etc. The term “aqueous liquid” will primarily refer to water.

### TECHNICAL BACKGROUND

In water arsenic mainly exists in a positive oxidation stage, i.e. As(+III) and/or As(+V) corresponding to As₂O₃ and As₂O₅, respectively. In aqueous liquids these forms are hydrated to arsenite and arsenate (HAsO₂/AsO₂⁻ and H₃AsO₄/H₂AsO₄⁻/HAsO₄²⁻/AsO₄³⁻, respectively). In fresh ground water containing arsenic the proportion of As(+III) in relation to As(+III) plus As(+V) is relatively high. Upon contact with air, As(+III) is slowly oxidised to arsenate so that after a while essentially all arsenic will be present as As(+V). Both As(+III) and As(+V) are highly toxic to mammals including man. HAsO₂ is a weaker acid than H₃AsO₄ and exists in its zero-charged acid form at neutral pH while H₃AsO₄ is partially deprotonated and negatively charged at neutral pH.

The presence of arsenic in ground water is widespread and has lead to regulations setting up strict requirements for allowable levels in drinking water. Such levels typically are ≦10 μg/L. In addition to securing low levels of arsenic in potable water, it is also of big concern to do so in process and waste water, e.g. water pumped from mines, oil wells etc, all of which may contain high levels of arsenic and therefore would cause environmental damages if deposited untreated.

There are a number of different kinds of known adsorbent methods for lowering the levels of arsenic in water:

Particulate adsorbents containing nanoparticles of Fe₃O₄ or certain other transition metal oxides have been claimed to selectively adsorb certain anions including both arsenite and arsenate anions from water. The nanoparticles have been present in admixture with sand or some other inert particulate material. This group of adsorbents, in particular with Fe₃O₄, contains some of the most popular adsorbents for the removal of arsenic from aqueous liquids.

Another main group of adsorbents has been based on a solid phase to which cation exchange, anion exchange or metal chelate groups are covalently attached. The solid phase has typically been in particulate form and based on a water-insoluble polymer, which may be cross-linked or non-cross-linked and acting as a carrier for the covalently attached groups. The water-insoluble polymer has typically been a cross-linked copolymer comprising units of styrene together wih divinyl benzene, acryl amide together with bisacrylamide, methacrylamide together with bismethacrylamide, corresponding acrylates/methacrylates etc. The ion exchange groups and the metal chelate groups are part of the adsorbents.

Previously suggested cation exchange adsorbents have exhibited anionic groups, such as carboxylate or sulphonate groups. In order to secure binding to arsenic, it has been suggested to dope the adsorbents with metal oxide/hydroxide by first loading the cation exchanger with metal ions, such as Fe³⁺ or some other transition metal ions capable of binding to arsenic in a positive oxidation stage, followed by precipitation of the corresponding metal oxide/hydroxide within the pores of the solid phase. WO 9519321 (Etzel et al).

Previously suggested anion exchange adsorbents have exhibited cationic groups, e.g. weak anion exchange groups, such as protonated forms of primary, secondary and/or tertiary amino groups, and/or strong anion exchange groups, such as quaternary ammonium groups. Anion exchange adsorbents have been used in direct anion exchange for binding arsenate anion, and, if the pH conditions are properly adapted, theoretically also arsenite anion. Alternatively the anion exchange adsorbents have also been doped with metal oxide/hyroxide by first loading them with negatively charged transition metal ion complex of the same kinds of metal as discussed above for cation exchange adsorbents, whereafter the complex is transformed to metal oxide or metal hydroxide within the solid phase by precipitation. See e.g. U.S. Pat. No. 7,291,578 (SenGupta et al); U.S. Pat. No. 7,407,587 (Moller); US 20050205495 (Barett et al); US 20070241057 (Klipper et al); WO 2005069825 (SenGupta); WO 2006022863 (Gottlieb et al) etc.

The metal oxide/hydroxide doped ion exchangers discussed above have been shown to have an improved selectivity for arsenic in a positive oxidation stage.

Previously suggested metal chelate adsorbents typically have exhibited transition metal chelate groups in which the metal ion has been selected as discussed above for cation and anion exchange adsorbents, e.g. Fe³⁺, Cu²⁺ etc. Typical chelating groups (=chelators) have been tri dentate with coordinating atoms being amino nitrogens and/or carboxylate oxygens. Binding of arsenate has taken place by coordination of oxygen in arsenate to the central metal ion which remains chelated by the chelating group. Improved capacity and good selectivity for arsenate have been claimed for polystyrene-divinyl benzene copolymers exhibiting N,N-di(α-2-picoline) aminomethyl groups. Drawbacks have been found for other chelators, such as imino diacetic acid groups (IDA). See US 20070056911 (Zhao et al).

In many cases it has been appropriate to contact arsenic-contaminated water with an oxidation agent in order to transform arsenite to arsenate to secure removal of both forms from water. We have found that the presence of an oxidation agent during adsorption can negatively affect the desired adsorption when the adsorbents are metal chelat adsorbents. We believe that this may be the case also for other metal doped adsorbents

Reusability of the adsorbent is a key issue for making removal of arsenic by adsorption economically feasible. For adsorbents based on polymeric solid phases exhibiting cation exchange groups or anion exchange groups or metal chelate groups, desorption of adsorbed arsenic can take place under acidic, alkaline or neutral conditions. See the publications referenced above. With respect to adsorbents based on metal chelate groups and on precipitated particulate metal oxide/hydroxide, acidic conditions will implicate a risk for release and loss of metal ions. Alkaline conditions will implicate a risk for formation of precipitates of metal oxide/hydroxide within the solid phase of the chelate adsorbents. At extreme alkaline pHs there will also be a risk for release of metal ions in the form of metal-hydroxide complex anions (=[Me(OH)ₙ]^{(n-m)-}) where n is larger than the charge m of the naked metal ion). For both alkaline and acidic conditions, these drawbacks indicate that regeneration must take place with care.

Patent and patent applications cited in this specification are hereby incorporated in their entirety by reference. This in particular applies to US versions including international applications designating the US.

### OBJECTS OF THE INVENTION

The main object is to provide novel adsorbent methods and arrangements for the removal of arsenic from water which are advantageous in one or more respects relative to the previously suggested adsorbent methods. This means that the main object encompasses providing at least improvements with respect to one or more of the features given below.

An adsorbent method for removal of arsenic in a positive oxidation stage should utilize an adsorbent which enables adsorption in a batch mode and/or in a flow through mode. The latter includes flow conditions during adsorption to an unmixed or mixed fluidised bed, to a porous packed beds or to a porous monolithic bed etc. The adsorbents used in the invention should enable at least a) quick and simple adsorption of at least arsenate, b) high selectivity and high capacity for adsorption of at least arsenate, c) reduction of the concentration of arsenic in a positive oxidation stage (i.e. As(+III)+As(+V), e.g. arsenate and arsenate) to acceptable levels in waters processed according to the invention compared to state and/or local regulations and/or recommendations, d) quick and simple desorption of adsorbed entities including at least arsenate and preferably without separate extra step for reloading or activating the functional groups which are capable of capturing arsenic in a positive oxidation stage (regeneration), e) desorbed fractions containing arsenic which are easy to dispose etc. Features relating to adsorption/desorption include that the functional groups should be both easily accessible within the adsorbent and selective for arsenic in a positive oxidation stage. Accessibility typically relates to porosity including sufficient pore sizes and poor volumes of the adsorbent for quick mass transport and adsorption. This includes also pores within particles if the adsorbent comprises particles with pores allowing diffusive transport and adsorption within the particles. In the case of a bed mode, the adsorbent should support high flow rates and/or high pressure drops, e.g. adsorbents having a sufficient rigidity.

Presence of oxidation agents transforming As(+III) to As(+V) should be avoided during the step during which arsenate is adsorbed.

The arrangement of the invention should have features enabling improvements relating to at least one of the features given above for the methods.

### DRAWINGS

FIG. 1 illustrates an arrangement suitable to be used for the method aspects of the invention. Arrows indicate flow directions.

### INVENTION

The present inventors have recognized that the above-mentioned main objective may be accomplished by incorporating in an arsenic adsorption method either one or both of the features:

A) utilizing a metal chelate adsorbent in which the chelating group (=chelator) is at least tridentate (multi-dentate) with respect to amino nitrogens, and/or

B) utilizing an oxidation agent for transformation of As(+III) to As(+V) prior to adsorption, and securing that the oxidation agent is not present during the subsequent adsorption step removing arsenic from the aqueous liquid.

At least three, four, five or more of the amino nitrogens in (A) are selected amongst primary, secondary or tertiary amino nitrogens that are directly bound to sp³-hybridised carbon

There are two main aspects of the invention comprise: 1) an adsorbent method for the removal of arsenic in a positive oxidation stage from an aqueous liquid contaminated with this kind of arsenic, and 2) arrangements for carrying out the method.

The first aspect of the invention is a method for the removal of arsenic in a positive oxidation stage from an aqueous liquid. This aspect comprises the steps of:

i) providing a porous adsorbent which comprises a solid phase carrying a metal ion in a form (I) which is capable of binding arsenic in a positive oxidation stage to give a metal ion form (II) comprising the metal ion and the arsenic, or.

ii) contacting the aqueous liquid with the adsorbent under conditions promoting formation of form (II),

iii) separating the aqueous liquid from the adsorbent; and

iv) optionally regenerating the adsorbent and reusing it as the adsorbent provided in step (i) in one, two, three or more cycles comprising steps (i)-(iv).

Form (I) is typically a metal oxide/hydroxide or a metal chelate group covalently attached to the solid phase via its chelating group. Both the metal oxide/hydroxide and the metal chelate group contain the metal ion capable of binding arsenic in a positive oxidation stage.

Form (I) above is part of the adsorbent and typically comprises the above-mentioned metal chelate group.

The method of the invention comprises two main method aspects, which differ from each other depending on which one of the features (A)-(B) given above is imperative. In other words the first main method aspect in its broadest concept is characterized by providing an adsorbent according to feature (A) in step (i), while the second method aspect is characterized by including an oxidation prestep according to feature (B) in step (ii) prior to the actual adsorption. This oxidation prestep comprises the substeps of: a) adding an oxidation agent transforming As(+III) to As(+V) to the liquid, and b) securing that no added oxidation agent remains when the liquid is to enter the adsorbent.

First Method Aspect

The Adsorbent (Step (i))

In its broadest sense, this method aspect is characterized in that form (I) is a metal chelate group (I) which comprises a metal ion capable of binding arsenic in a positive oxidation stage and an at least tridentate amino chelating group (=multidentate amino chelating group) covalently attached to the solid phase. Chelate group (I) is capable of being transformed to a metal chelate group (II) (=form (II)), which comprises the metal ion, arsenic in a positive oxidation stage and the chelating group.

The expression “at least tridentate” means that the chelating group comprises three, four or more amino nitrogens which are directly attached to sp^{a}-hybridised carbon and capable of simultaneously coordinating to a metal ion in an at least triplet wise manner. The expression “at least triplet-wise manner” means that the amino nitrogens are positioned relative to each other such that each of them together with two or more of the other amino nitrogens are capable of simultaneously coordinating to the same metal ion (common metal ion) to the formation of two or more rings each of which contains two of the amino nitrogens and the metal ion. The preferred rings are five- and/or six-membered. The maximum number of nitrogens coordinating to the same metal ion is determined by steric considerations and is as a rule≦the coordination number for the metal ion, with preference for<in order to give place for binding of arsenic in a positive oxidation stage. The number of rings formed incorporating the same common metal ion is one less the number of amino nitrogen coordinating to this metal ion.

In further preferred variants all carbons directly attached to the amino nitrogen discussed above for the metal chelate group (I) are sp³-hybridised, i.e. these nitrogen atoms only bind directly sp³-hybridised carbon.

The distance between two neighbouring coordinating (chelating) amino nitrogen atoms in the chelating group is preferably two or three atoms but may also be longer. Two, three or more of the atoms defining the distance or chain between two neighbouring coordinating amino nitrogens are typically sp³-hybridised carbons, e.g. carbon atoms only binding carbon and/or hydrogen in addition to the neighbouring nitrogen atoms.

In preferred chelating groups there are typically ≧5, such as ≧10 or ≧20 or ≧50 amino nitrogens of the kind discussed above. As a rule the number is typically ≦2000, such as ≦500.

In preferred variants a metal chelate group (I) comprises one, two, three, four or more chelated metal ions of the same or similar kind.

The most preferred chelating groups are based on polyethylene imine (=PEI) structures and thus exhibit repetitive ethylene imine units, i.e. —CH₂CH₂—N<where the left free valence typically binds to the nitrogen in another ethylene imine unit or to an amino nitrogen such as in NH₂—, and each of the two right free valences bind to hydrogen or to the left free valence in another ethylene imine unit. A PEI structure as a rule comprises at least three repetitive ethylene imine units and may be branched or linear. PEIs of mean molecular weights in the interval of 125-2×10⁶ Daltons, such as 10⁴-10⁶ Daltons or 10⁴-0.5×10⁶ Daltons, are commercially available and possible to attach covalently to different solid phases by well known techniques, primarily via their primary, secondary and/or tertiary amine function.

In addition to the amino nitrogens described above, the chelating group may also comprise other nitrogens capable of coordinating/chelating to the same common metal ion together with amino nitrogen of the above mentioned kind and/or with other kinds of nitrogens in an at least pair wise manner. Illustrative such other nitrogens are amido nitrogens, nitrogens that are part of aromatic rings (e.g. nitrogen in pryridine rings, quinoline rings etc. In less preferred variants there may also be other chelating heteroatoms although as for amino and amido nitrogens it is imperative that they are uncharged when coordinating/chelating to the metal ion. The rules are the same for the distance between these metal ion coordinating heteroatoms as for the amino nitrogens discussed above. Thus the preferred distance is two or three atoms without imperative need for sp^{a}-hybridised carbon next to a heteroatom.

The metal ion in the metal chelate (I) of the adsorbent shall be selected among metal ions that are capable of forming relatively stable complexes and/or insoluble salts with arsenate and/or arsenite. Such metal ions are known from the scientific as well as the patent literature. Experimental testing comprising preparing different candidate combinations and varying the conditions for adsorption and/or desorption will be useful for finding efficient combinations of metal ion and adsorbent-bound chelating groups. As a rule suitable metal ion candidates can be found amongst ions of the transition metals, e.g. iron ions, cupper ions, titanium ions, certain lanthanide ions etc which are known for binding arsenate either in chelated form or in the form of their oxides/hydroxides. In this context it is worth noting that significant binding of arsenite also has been considered under the appropriate pH conditions. In the context of the invention the lanthanides will be included amongst the transition metals.

Preferably the metal ion and the chelating group is selected such that there exist an alkaline pH interval at which the metal ion is retained in chelates (I) and (II) while arsenic in a positive oxidation stage is released from chelate (II). Such pH-values may be found for pH ≦14 or ≦13 or ≦12 or ≦11 and/or ≧8 or ≧9 or ≧10, with particular emphasis of intervals that are combination of these upper and lower pH-intervals (and). This kind of metal chelates will support desorption and regeneration at alkaline pH without or with a lowered need for reloading with metal ion in order to regenerate the adsorbent provided in step (i) after adsorption of arsenic.

Physically the adsorbent may be in the form of a fixed bed which encompasses forms such as beads/particles packed to a porous bed and porous continuous beds (=porous integral matrixes), such as porous plugs (monoliths) and porous membranes. The adsorbent may alternatively be in the form of a fluidised bed that may be in expanded form (also called unmixed, stabilised or classified bed) or be completely mixed or stirred. Fixed beds and expanded beds are preferred since chromatographic principles then can be applied meaning a more efficient utilization of the adsorbent. Mixed or stirred variants of fluidised beds are best suited for batch processes.

Adsorbents in the form of expanded beds are in particular useful for unfiltered aqueous liquids that contain particulate matters that implicate a risk for early clogging of a fixed bed.

The adsorbent is typically hydrophilic in the sense that it is capable of being saturated with water by self-suction, provided it is in a fixed bed format and placed in liquid contact with an excess of water.

Adsorbent particles may have regular or irregular forms. Particularly useful particle forms are rounded (=beaded particles) and include various kinds of spheres and spheroids. Particle sizes (mean sizes/diameters) in an adsorbent used in the method are typically in the range of ≧25 μm, such as ≧50 μm or ≧75 μm or ≧μ150 μm or ≧250 μm, with preference for mean sizes ≧150 μm or ≧250 μm. Upper limits for mean sizes are typically 1 mm, 2 mm or 3 mm. The particles may be monosized/monodispersed or polysized/polydispersed. Monosized/monodispersed particles contemplate that the particles of the adsorbent have a size distribution with ≧70%, such as ≧85% or ≧95% of the particles falling within a size/diameter range which width is 0.1 to 10 times the mean particle diameter, preferably 0.3 to 3 times the mean particle diameter. For an irregular particle, the size/diameter is the longest distance/diameter between two opposite sides of the particle. Particle populations that are not monosized are polysized.

The adsorbent is typically built up of a porous base matrix (solid phase). The chelating group is covalently attached to the inner surfaces (=pore surfaces) and outer surfaces of the base matrix. The matrix may be built up of organic and/or inorganic material. It typically comprises a polymeric network exposing polymer chains and hydrophilic groups, e.g. hydroxy groups and/or amide groups, on the inner and outer surfaces of the matrix which will be in liquid contact with the arsenic-contaminated water that is to pass through the adsorbent. Suitable polymers are mostly organic and/or of biological origin (biopolymers), even if synthetic polymers are also may be used. The polymers typically exhibit a plurality of hydroxy groups and/or amide groups and are thus polyhydroxypolymers and/or polyamide polymers. In the polyamide polymers the amide groups are typically projecting from the polymer chain. Examples of useful biopolymers are polysaccharides with base matrixes/adsorbents based on e.g. dextran (Sephadex™, GE Health Care, Uppsala Sweden), agarose (Novarose™, Innovata, Bromma, Sweden; and Sepharose™, GE Health Care, Uppsala Sweden), starch, cellulose (Sephacel™, GE Health Care, Uppsala Sweden) etc. Appropriate examples of synthetic polymers are poly hydroxyalkyl acrylates, poly hydroxy alkyl methacrylates, poly hydroxy alkyl vinyl ethers, poly acryl amides and poly methacryl amides. Amides are many times N-substituted with hydroxy-containing groups, e.g. hydroxy alkyl. Cross-linking structures in synthetic polymers are typically introduced when the polymers are produced by including the appropriate cross-linking monomer during the polymerization process. Suitable biopolymers and synthetic polymers typically exhibit a plurality of hydrophilic functional groups along the polymer chains. Each of these functional groups as a rule exhibits one or more heteroatoms (oxygen, nitrogen and sulphur) and is typically selected amongst hydroxy or amido, for instance. The polymers therefore typically have a pronounced hydrophilic character. Also purely hydrophobic polymers, such as polystyrenes including styrene-divinyl benzene copolymers, may be used. The inner and outer surfaces of base matrices built up of hydrophobic polymers are typically hydrophilized, for instance by introducing a coat of sufficient hydrophilicity on them. This kind of coat may be introduced by a) physical adsorption or b) grafting of coat molecules that subsequently may be cross-linked. Hydrophilicity may also be introduced during the polymerization process by using the appropriate conditions including for instance presence of monomers that have a polymerizable hydrophobic end and a hydrophilic end. Suitable coating agents are the above mentioned hydroxy-group containing polymers or a low molecular weight hydroxy group containing compound. See for instance polystyrene-divinyl benzene particles sold under the name Source™ (GE Health Care, Uppsala, Sweden).

Suitable adsorbents to be used in the invention may be achieved by replacing the hydrogen on a plurality of the hydroxy groups of the kind of base matrixes/solid phases discussed above with chelating groups. The attachment of the chelating group to the base matrix is preferable at oxygens that originally are present as hydroxy groups. If a chelating group is attached at several points it may define a cross-link.

A hydrophilic polymer is typically defined as a polymer in which the ratio between the sum of the number of carbon atoms and the sum of the number of the heteroatoms (oxygen, nitrogen and sulphur) is ≦4, such as ≦3 or ≦2.

The adsorbent particles may contain inorganic material. This in particular applies when the adsorbent is used as an expanded bed in which inorganic particulate material typically is embedded within the adsorbent particles for increasing their densities (expanded beds typically require particle densities that are higher than the density of water).

The porosity of the adsorbent bed should be sufficient for high flow rates through the adsorbent without applying too high pressures. This typically means that if the bed is build up of particles they should be large, typically ≧150 μm, more preferably ≧250 μm such as ≧350 μm (mean particle diameter) with a narrow particle size distribution (see above for suitable size distribution intervals). Upper limits are as discussed elsewhere in this specification.

To withstand the high pressure needed for running the process of the invention at sufficiently high flow rates to accomplish high productivity, the adsorbent when used as a fixed bed should have a considerable rigidity. As a general guideline the adsorbent should permit flow rates of at least 500 cm/h, such as at least 1000 cm/h, when the adsorbent material is placed in a model column of 8×300 mm (diameter x height) and water is used as the eluent.

Introduction of the chelating group onto the solid phase is typically done by well known techniques. A particularly preferred method involves activation of hydroxy groups on the solid phase by allylation followed by halogenation of the introduced allyl double bond and immobilization of the appropriate nucleophilic chelator molecules, e.g. PEI (where the nuccleophilic group reacts with the halogenated allyl group). Preferred nucleophilic groups for this kind of immobilization are amino groups and thiol groups. See for instance WO 94004192 (G Lindgren).

Loading of the metal ion is done by well known techniques by contacting the adsorbent with an aqueous solution in which the corresponding metal salt is dissolved. It is important to select a pH at which essentially all or at least the major part of the amino groups is unprotonated, i.e. in their amino form. A too high pH should be avoided since this might complicate the loading process by formation of precipitates of metal oxides/hydroxides. Suitable pH conditions are typically found in the pH interval 5-10.

The Adsorption Step (Step (ii))

This step comprises contacting the aqueous liquid which contains arsenic in a positive oxidation stage with the adsorbent under conditions promoting formation of form (II) as a chelate. (=chelate (II)). The adsorbent is typically placed in a reactor vessel having an inlet and an outlet for the aqueous liquid.

The demand on pH is similar to the conditions used for loading the adsorbent with metal ions. Suitable pH values may found in the interval pH 5-10, such as ≧6 and/or ≧9.

The reduction in total concentration of As(+III) and As (+V) in step (ii) should be ≧50%, such as ≧60% or ≧75% or ≧90% or ≧95% or ≧99%. For lower concentrations of arsenic upstream of the adsorbent acceptable reductions may be smaller than for higher concentrations. The important matter is that the concentration of As(+III) and/or As(+V) in the aqueous liquid after step (iii) is acceptable according to state and/or local health and/or environmental regulations and/or recommendations. This typically means that the concentration of arsenic in a positive oxidation stage downstream of the adsorbent should be ≦10 μg/L, such as ≦5 μg/L

The contacting may take place under flow conditions or non-flow conditions. Flow conditions means that the arsenic-containing aqueous liquid is allowed to pass through the adsorbent during the adsorption with the adsorbent retained in a suitable vessel. If the adsorbent is an expanded bed or a fixed bed as discussed above chromatographic conditions can be established which typically means an efficient utilization of the adsorbent (adsorption in chromatographic mode). Fixed beds of the kind discussed above are preferred. Non-flow conditions normally means batch-wise mode. The adsorbent is then typically in the form of adsorbent particles suspended in an adsorption vessel with the inlet and/or outlet closed during adsorption. This variant typically results in a less efficient utilization of the adsorbent compared to flow conditions with unmixed fluidised and fixed beds.

Pretreatment of the Aqueous Liquid (Belongs to Step (ii))

Step (ii) also comprises various presteps for treading raw water that are to be provided for adsorption according to the invention. Depending on the origin of the raw water the water may contain components in the form of solutes or insoluble matters (solids, semisolids, oils, slimes etc) that would lower the efficiency of the adsorption. Thus insoluble matters may be removed by presteps including one or more of mechanical filtration, sedimentation, decantation, phase separation, precipitation, dissolution reactions etc. Solutes may be removed by precipitation, filtration through active filters, membranes and the like having capture groups for the undesired component, chemical transformation to un-disturbing entities etc. If the pH of the raw water is unsatisfactory pH-adjustment can be done.

In ground water, water pumped from oil wells, mines etc there are typically relatively high levels of As(+III) (arsenite) compared to the total amount of arsenic in a positive oxidation stage. Since most metal chelate adsorbents like most other metal doped adsorbents are inefficient in removing arsenite, step (ii) advantageously includes a prestep for oxidation of arsenite to arsenate. This is typically done by adding an oxidation agent capable of transforming arsenite to arsenate to the aqueous liquid at a position upstream of the adsorbent.

A number of oxidation agents has been suggested for oxidation of As(+III) to As(+V). In principle anyone of them might be used but some of them are less preferred because they lead to precipitates that have to be removed before the adsorption or to toxic solutes that are not acceptable in water to be deposited in nature, used as potable water or for watering fields etc. Thus, in preferred variants which comprises an oxidation prestep, the oxidation agent should be water-soluble and selected among those that are capable of oxidizing As(+III) to As(+V) resulting in only water-soluble products, typically in concentrations that are harmless from an environmental and/or health aspect, e.g. non-toxic products or non-toxic concentrations of toxic products. Examples of such products are halide ion (in particular Cl⁻), H₂O etc. Arsenate is an acceptable oxidation product because it is removed by the adsorbent. Illustrative suitable water-soluble oxidation agents can be found in the group consisting of O₃, peroxides (H₂O₂ and organic and inorganic compounds exhibiting the peroxide group (—O—O—)), halogens (X₂) and halogen-oxygen containing oxidation agents, such as XO⁻, X₂O, XO₂⁻, XO₃⁻, XO₄⁻ etc). For the time-being the top preference is for ozone, i.e. O₃, and halogen-containing oxidation agents in which X is Cl with special emphasis for XO⁻.

As said above we have recognized that the oxidation agent, if present during the adsorption, can result in a lowered adsorption of arsenate. One should therefore secure that the oxidation agent is absent during the adsorption. In preferred variants, step (ii) therefore comprises that the actual adsorption i.e. the contact between the water and the adsorbent, is preceded by the substeps of: a) oxidising essentially all arsenic in oxidation stage +III (i.e. arsenite) to oxidation stage +V (i.e. arsenate) by adding an oxidation agent to the aqueous liquid, and b) securing that zero amounts of the oxidation agent remains in the aqueous liquid that is about to pass through the adsorbent. Zero amounts in this context includes insignificant amounts i.e. amounts that permit the adsorption to proceed as desired. Zero amounts can be accomplished by one or more of a) adding only the amounts needed for transforming all arsenite to arsenate plus what is needed for competing oxidations, i.e. an equivalent amount of the oxidation agent, b) adding an agent neutralizing unused oxidation agent (e.g. a reducing agent), c) allowing for sufficient time to lapse before initiating the adsorption etc. Suitable reducing agent should be non-toxic and/or should result in products that are non-toxic (either non-toxic as such or in non-toxic levels). For flow systems the reaction time for the oxidation to be completed may be changed as required by changing the flow velocity and/or by adapting the internal volume of the reaction zone of the system, i.e. the internal volume between the position for adding oxidation agent and the position at which the oxidation of As(+III) is finalised (e.g. the position of the inlet end of the adsorbent). One alternative is to add an excessive amount of oxidation agent and subsequently stop the oxidation by removing the excess at a position upstream of the adsorbent, e.g. by chemical means.

In order to facilitate zero amounts of oxidation agents that are to enter the adsorbent in substep (b) of the oxidation prestep defined above, the method thus may comprise the steps of:

b.i) measuring/determining the level of the oxidation agent remaining in the aqueous liquid after the oxidation and/or the level of As(+III) in the liquid prior to and/or after the oxidation, and

b.ii) adapting the amount of oxidation agent to be added to the measured/determined amount in substep (b.i).

The oxidation prestep may comprise addition of oxidation agent in excess followed by neutralization of the excess by addition of a reducing agent after oxidation and/or by passing the liquid through a filter which removes the excess, e.g. by adsorption.

Second Method Aspect

As for the first method aspect this aspect is a method comprising the steps of:

i) providing a porous adsorbent which comprise, a solid phase carrying a metal ion in a form (I) which is capable of binding arsenic in a positive oxidation stage to give a metal ion form (II) which comprises the metal ion and the arsenic,

ii) contacting the aqueous liquid with the adsorbent under conditions promoting formation of form (II),

iii) separating the aqueous liquid from the adsorbent; and

iv) optionally regenerating the adsorbent and reusing it as the adsorbent provided in step (i) in one, two, three or more cycles comprising steps (i)-(iv).

Form (I) is typically a metal oxide/hydroxide or a metal chelate group covalently attached to the solid phase via its chelating group. Both the metal oxide/hydroxide and the metal chelate group contain the metal ion capable of binding arsenic in a positive oxidation stage.

As already indicated the imperative characterizing feature for the second method aspect is that step (ii) prior to the contact between the arsenic-containing aqueous liquid and the adsorbent comprises the substeps of: a) oxidising As (+III) to As(+V) of the liquid by an oxidation agent added to the aqueous liquid before the aqueous liquid is contacted with the adsorbent, and b) securing that zero amounts of oxidation agent from substep (a) remains in the aqueous liquid when the adsorption part of step (ii) is initiated.

In principle various subaspects of the second method aspects are as indicated for the first method aspect:

a) Suitable metal ions can be selected by following what has been outlined for the first method aspect.

b) Suitable chelating groups are as outlined for the first method aspect but in less preferred variants it is believed that the chelating groups in addition to uncharged chelating/coordinating hetero atoms there may also be present negatively charged oxygen atoms, such as in caboxylate (—COO⁻), phosphonate (—PO₃H⁻, —PO₃²⁻), sulphonate (—SO₂⁻). The rules are the same for the distance between these metal ion coordinating heteroatoms as for the amino nitrogens discussed above. Thus the preferred distance is two or three atoms without imperative need for sp³-hybridised carbon next to a heteroatom.

c) Suitable conditions for adsorption and desorption can be applied as previously known for metal-doped arsenic binding adsorbents with due care taken with respect to applying the principles outlined herein for the adsorbents used in the first method aspect of the invention.

Regeneration of the Adsorbent and Performing Cycles of Steps (i)-(iv)

Both aspects of the method of the invention preferably comprises a step (iv) comprising the substeps of: a) regenerating the adsorbent by desorption of entities adsorbed during step (ii) including arsenic in a positive oxidation state in order to transform form (II)/chelate (II) to form (I)/chelate (I); and b) optionally reusing the so regenerated adsorbent as the adsorbent provided originally in step (i) in one, two, three more cycles of steps (i)-(iv).

The actual desorption may take place under acidic, neutral or alkaline conditions. If taking place under acidic or neutral conditions the risk for simultaneous loss of the metal ion may be significant. Acidic conditions typically include passing dilute hydrochloric acid or dilute sulphuric acid where dilute refer to molar concentrations ≦4 M such as ≦2 M or ≦1 M with a typical lower limit being 0.05 M. For acidic conditions recharging with metal ions that are capable of forming arsenic-binding metal forms/chelates with the metal binding/chelating group in the original adsorbent will be more or less imperative. In the most preferred variants, desorption as part of the regeneration is taking place under alkaline conditions. However, this requires that the metal binding/chelating group and metal ion in the starting adsorbent are selected relative each other such that adsorbed arsenic can be released from form (II)/chelate (II) without release of the metal ion and without concomitant precipitation of metal oxide/hydroxide within the adsorbent. Suitable pH conditions for this can be found in the pH interval pH ≦14 or ≦13 or ≦12 or ≦11 and/or ≧8 or ≧9 or ≧10

If two, three or more cycles of steps (i)-(iv) are carried out with desorption under the above-mentioned alkaline conditions the need for always recharging with metal ion between the cycles will be low. Since there still may be partial loss of chelated metal ion, it may be appropriate to recharge the adsorbent with the metal ion subsequent to at least two, at least three, at least four, at least five or more consecutive cycles not utilizing recharging with the metal ion.

What has been said above about metal chelate (I) and metal chelate (II) in the context of regeneration in the first method aspect includes that the chelated metal ion may differ between cycles in a cyclic process. In other words during recharging with metal ion it is at least theoretically possible to switch to another kind of arsenic-binding metal ion.

When the adsorbent is in the form of a fixed bed, an efficient way to carry out regeneration of the adsorbent is to pass in sequence the regeneration solutions of a cycle through the bed. At least one of the solutions is the actual desorbing solution providing the desired desorbing conditions. This solution is typically preceded and/or followed by one or more conditioning or washing solutions. The regeneration is, if so required, ended by one or more metal ion recharging solutions possibly followed by one or more conditioning or washing solutions. At least the desorbing solutions are preferably passed through the bed in the opposite flow direction compared to the flow direction during adsorption.

The Arrangement Aspect

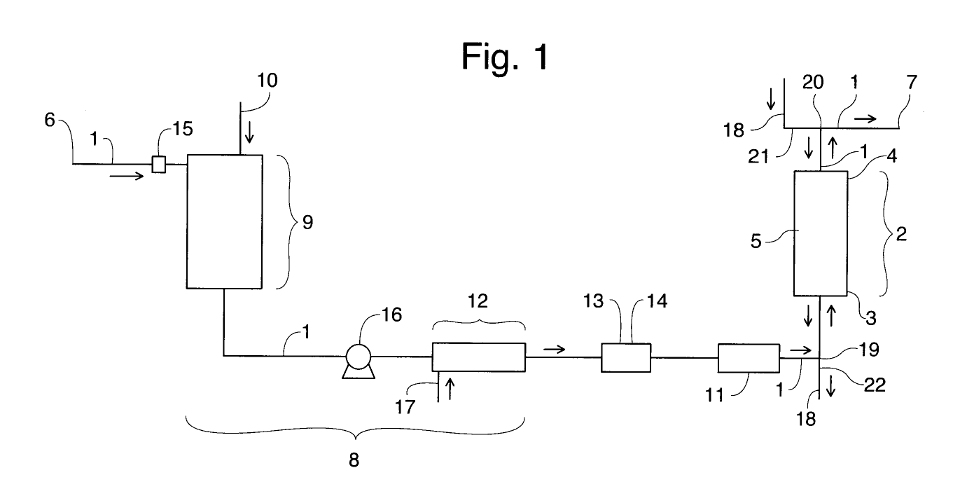

This aspect is an arrangement adapted for carrying out removal of arsenic in a positive oxidation stage from an aqueous liquid as generally described by the second method aspect, i.e. a method which comprises oxidation of As (+III) to As(+V) as a part of step (ii). The arrangement is illustrated in FIG. 1 and comprises a main flow line (1) for the As-containing aqueous liquid and an adsorption zone (2) in its downstream part. The adsorption zone (2) has an inlet end (3) and an outlet end (4) and contains a porous adsorbent (5) which comprises a solid phase exhibiting a metal ion in a form (I) which is capable of binding arsenic in a positive oxidation stage to give a metal ion form (II) which comprises the metal ion and the arsenic in a positive oxidation stage. Form (I) is typically a) a metal oxide/hydroxide of the metal ion, or ii) a metal chelate of the metal ion covalently attached to the solid phase via its chelating group. See discussion above for the method aspects of the invention.

The upstream or inlet end (6) of the flow line (1) is in the upstream direction capable of being connected to a source (not shown) for an arsenic-containing aqueous liquid and the downstream end (7) is used for leading aqueous liquid having been depleted in arsenic within zone (2) away from the arrangement.

The characterizing feature of the arrangement aspect is that the flow line (1) between the upstream end (6) and the adsorption zone (2) comprises an oxidation zone (8) in which there in downstream order is

(a) an oxidation reaction zone (9) with an inlet flow line (10) for an oxidation agent capable of oxidising As(+III) to As(+V), and

(b) a zone (12) in which the oxidation agent is neutralized (=oxidation agent neutralizing zone (12)).

The inlet flow line (10) for the oxidation agent is connected to the upstream part of the oxidation reaction zone (9). The oxidation agent is typically selected as outlined for the second method aspect. See also the first method aspect.

The neutralizing zone (12) may be based on various principles for neutralizing the activity of the oxidation agent by removing and/or transforming it to a form (=inert form) not adversely affecting the adsorption of arsenic in a positive oxidation stage in the adsorption zone (2), i.e. scavenging (=inactivation) of the oxidation agent. Thus it may be based on a) filtration through a filter which adsorbs and/or transforms the oxidation agent to an inert form, b) addition of a reducing agent etc. See above for the second method aspect.

In addition, the main flow line (2) may also comprise a filter function (11) located downstream of the neutralizing zone (12) for removing particulate matter. Particulate matters can derive from the source of the As-containing liquid and/or can be the result of the oxidation of As(+III) and/or the removal of the oxidation agent by chemical agents. Formation of particulate matters thus can depend on the particular oxidation agent selected and/or of chemical agents used for the removal of the oxidation agent.

In association with the oxidation zone (8) there can also be present a sensor arrangement comprising

a) a sensor for measuring the level of oxidation agent at a position (13) downstream of the oxidation reaction zone (9) and/or

b) a sensor for measuring the level of As(+III) at a position (14) downstream of the oxidation reaction zone (9) and/or

c) a sensor for measuring the level of As(+III) at a position (15) upstream of the oxidation reaction zone (9).

A pump function (16) is typically associated with the main flow line (1), e.g. within the oxidation zone (8) or upstream or downstream of this zone or upstream or downstream of the adsorption zone (2).

During use of the arrangement the flow line (10) for introduction of oxidation agent is connected to a source of oxidation agent (not shown) and suitable pumps (not shown) if the source is a storage vessel for the oxidation agent and/or a generator (not shown) for oxidation agent (for instance an ozone generator).

The presence of a flow line (10) for inlet of oxidation agent may be combined with the presence of a inlet flow line (17) for an agent capable of neutralising excess oxidation agent present in the liquid after oxidation of As(+III) to As(V) has taken place. This neutralizing agent is typically a reducing agent. During use of the arrangement the inlet fow line (17) for the neutralizing agent is typically connected to a source (not shown) for this agent and suitable pumps (not shown) if the source is a storage vessel.

As indicated for the second method aspect above, it is important to balance the internal volume of the oxidation reaction zone (9) against the flow velocity through the zone in order to allow for sufficient retention time within the zone for the oxidation of As(+III) to be completed. Therefore it may be appropriate for the pump function (16) to be adjustable with respect to flow velocity through the oxidation reaction zone (9). There may also be advantages by arranging so that the internal volume of the oxidation reaction zone (9) is also adjustable.

The arrangement may also comprise a flow line (18) for regeneration liquids that are to pass through the adsorbent zone (2). The part of flow line (18) passing through the adsorption zone (2) is typically common with the part of the main flow line (1) passing through this zone. Flow line (18) typically has an inlet portion (21) and an outlet portion (22) connected to the part of main flow line (1) via 3-way valve arrangements (20 and 19, respectively). The part of the main flow line between the inlet part and outlet part of flow line (18) is common for the two flow lines (1,18) and includes the adsorption zone. As indicated in FIG. 1 the flow direction of the regeneration liquids is preferably reversed compared to the flow direction during adsorption at least for the desorption liquid.

The arrangement may also comprise a software based control unit connected to the sensor arrangement and to the pump functions of the system for automatic adaptation of the amount of oxidation agent and/or neutralizing agent introduced into the aqueous liquid via the inlet for the oxidation agent to the concentration of As(+III) to give acceptable levels of oxidation agent and/or of As(+III) at the inlet end of the adsorbtion zone (2).

Best Mode

The best mode at the priority date and at the first anniversary date is given by preferred clauses in the specification and also illustrated in the experimental part. In the future it is believed that systems of the kind discussed under “The arrangement aspect” will be most advantageous. When the water to be processed contains no As(+IV) it will be preferred to omit the oxidation zone.

### Experimental Part

Oxidation Pre-Treatment Followed by Adsorption (Batch Mode and Chromatographic Mode)

Oxidation of As(+III) to As(+V):

Ozone was generated using an ozone generator (ACT-3000 P, OzoneTech Systems (www.ozonetech.com)). The generator is rated to produce at maximum 200 mg ozone/h and was set at 25% effect for 0.5-5 minutes during the oxidation step in each experiment. An aquarium pump was used to give a small air flow through the generator. The air flow containing ozone leaving the generator was bubbled through a sample of water which contained a mix of As(+III) and As(+V) at a total concentration of about 3500 ppb. The volumes of the water samples varied within 30-60 mL between different experiments.

Adsorption:

Adsorbent: 500 μm agarose beads prepared according to WO 2008146742 (Bio-Works) to which polyethyleneamine was covalently attached by activating the beads by allylation and subsequent halogenation of introduced allyl groups. See further WO 1994004192 (Inovata AB). The capacity of the adsorbent for binding Cu ions was 15-20 g/L.

Adsorption mode: These experiments were carried out as batch uptake tests in a bottle with a ratio of adsorbent/water of 1:20.

Chromatographic mode: These experiments were carried out in a column with the volume of the adsorbent being 25 mL and a flow allowing for a contact time of 5 minutes.

After the oxidation step each sample was a) directly contacted with the adsorbent without removal of excess ozone or b) stirred or vacuum treated for 30 min for removal of excess ozone.

Water samples were tested arsenic content at ALS Laboratory Group, Sweden before oxidation, between oxidation and adsorption and after adsorption.

Results: More than 30 different experiments were done. Representative results are:

1. Batch uptake test without pre-treatment with ozone. 500 ppb of arsenic remained in the supernatant

2. Column test: Samples of 60 mL were treated 30 min with ozone at 25% effect of the ozone generator and with 30 min stirring to remove excess ozone. 0 ppb of arsenic remained in the eluate.

3. Column test: Samples of 60 mL were treated 30 min with ozone at 25% effect of the ozone generator and with 30 min vacuum treatment to remove excess ozone. 0 ppb of arsenic remained in the eluate.

4. Column test: Samples of 60 mL were treated 30 min with ozone at 25% effect of the ozone generator and with no treatment to remove ozone: 174 ppb of arsenic remained in the eluate.

Conclusion: Ozone will oxidise all As³⁺ but excess ozone will also inhibit binding, see experiment 4 above. It is important to balance the addition of ozone with the amount of Arsenic present and to have a degassing operation in order to prevent excess ozone. We can now conclude that by oxidising arsenic we can remove almost all arsenic.

While the invention has been described and pointed out with reference to operative embodiments thereof, it will be understood by those skilled in the art that various changes, modifications, substitutions and omissions can be made without departing from the spirit of the invention. It is intended therefore that the invention embraces those equivalents within the scope of the claims which follow.

1. A method for the removal of arsenic, which is in a positive oxidation stage, from an aqueous liquid contaminated with this kind of arsenic, comprising the steps of:
i) providing a porous adsorbent which comprises a solid phase carrying a metal ion in a form (I) which is capable of binding arsenic in a positive oxidation stage to give a metal ion form (II) comprising the metal ion and the arsenic;
ii) contacting the aqueous liquid with the adsorbent under conditions promoting formation of form (II),
iii) separating the aqueous liquid from the adsorbent,
iv) optionally regenerating the adsorbent, and reusing it as the adsorbent provided in step (i) in one, two, three or more cycles comprising steps (i)-(iv), wherein
A) form (I) is a metal chelate (I), which
a) comprises a metal ion and an at least tridentate (multidentate) chelating group which is covalently attached to the solid phase,
b) comprises three, four or more amino nitrogens which are directly attached to sp³-hybridised carbon and in an at least triplet wise manner are capable of coordinating to a metal ion, and
c) is capable of being transformed to a metal chelate (II) (form (II)), which comprises the metal ion, arsenic in a positive oxidation stage and the chelating group, and/or B) step (ii) prior to the contact between the aqueous liquid and the adsorbent comprises the substeps of:
a) oxidising As(+III) to As(+V) by an oxidation agent added to the aqueous liquid before the aqueous liquid is contacted with the adsorbent, and
b) securing that zero amounts of oxidation agent from substep (a) remains in the aqueous liquid when contact between the aqueous liquid and the adsorbent is initiated.

2. Method of claim 1, wherein the metal coordinating heteroatoms of the chelate are uncharged.

3. The method of claim 1, wherein there is a distance of two or three atoms, between two neighbouring coordinating nitrogen atoms.

4. The method of claim 1, wherein said metal ion and said chelating group have been selected such there exist an alkaline pH interval at which the metal ion is retained in chelates (I) and (II) while arsenic in a positive oxidation stage is released from chelate (II).

5. The method of claim 1, wherein the chelating group is a polyethylene imine group.

6. The method according to claim 1, wherein the metal ion is selected amongst the transition metal ions.

7. The method of claim 1, wherein step (iv) is carried out.

8. The method of claim 7, wherein step (iv) is carried out and performed with desorption under alkaline conditions, and the pH during desorption is carried out at an alkaline pH at which the metal ion is retained in chelates (I) and (II) while arsenic in a positive oxidation stage is released from chelate (II).

9. The method of claim 1 wherein alternative (B) of claim 1 is not included in the method.

10. The method of claim 1, wherein alternative (B) of claim 1 is included in the method.

11. The method of claim 10, wherein the oxidation agent is selected among those that are capable of oxidizing As(+III) to As(+V) resulting in only water-soluble products.

12. The method of claim 1, wherein the liquid contact surfaces of the solid phase expose a poly hydroxy polymer to which the chelator is covalently attached.

13. The method of claim 1, wherein it is a chromatographic procedure with the adsorbent placed in a porous bed or fluidised bed column through which the aqueous liquid is allowed to pass thereby providing flow conditions during the adsorption of arsenic to the adsorbent.

14. The method of claim 3, wherein there is a distance of two atoms between two neighbouring coordinating nitrogen atoms.

15. The method of claim 3, wherein each of said two or three atoms are sp³-hybridised.

16. The method of claim 14, wherein each of said two atoms are sp³-hybridised.

17. The method of claim 4, wherein the alkaline pH is ≦13 and ≧10.

18. The method according to claim 6, wherein the metal ion is Fe³⁺.

19. The method of claim 8, wherein the alkaline pH is ≦13 and ≧10.

20. The method of claim 11, wherein the oxidation agent is selected from the group consisting of O₃, peroxides (H₂O₂ and organic and inorganic compounds exhibiting the peroxide group (—O—O—)), halogens (X₂) and halogen-oxygen containing compounds.
